(19) United States
(12) Patent Application Publication
(10) Pub. No.: US 2005/0043429 A1
(43) Pub. Date: Feb. 24, 2005

(54) Method for preparing films based on cross-linked poly(ethylene oxide)

(76) Inventors: Christo Tsvetanov, Sofia (BE); A Rayna Stamenov, Sofia (BE); Gerard Riess, Mulhouse (FR); Maria Ferrand, Sierentz (FR); David Limal, Julien En Genevois (FR)

Correspondence Address: DENNISON, SCHULTZ, DOUGHERTY & MACDONALD, 1727 KING STREET, SUITE 105, ALEXANDRIA, VA, 22314, US

(21) Appl. No.: 10/498,520

(22) PCT Filed: Dec. 20, 2002
(86) PCT No.: PCT/FR02/04496

(30) Foreign Application Priority Data
Dec. 20, 2001 (FR) 0116519

(51) Int. Cl. C08G 2/00

(52) U.S. Cl. 522/100

(57) ABSTRACT

The present invention relates to a novel method of preparing films based on cross-linked poly(ethylene oxide). This method comprises the steps consisting in: a) dissolving said polymer or copolymer of ethylene oxide, alone or in a mixture, with a water-soluble polymer, in a solvent system made up of water, an organic solvent, or a mixture in any proportion. of water and of organic solvent, in the presence of an effective amount of a photo-initiating agent or of a cross-linking agent; b1) either drying the solution thus obtained until the solvent system has evaporated, when this solvent system is made up exclusively of an organic solvent, to thus obtain a dry film, and treating the film thus obtained under conditions enabling an amount of water to be absorbed of between 10 and 100% by weight with respect to the weight of the polymer; b2) or drying the solution thus obtained until the solvent system has evaporated, when this solvent system is made up of water or a water-organic solvent mixture, to thus obtain a film containing between 10 and 100% by weight of water with respect to the weight of the polymer; c) irradiating the film thus obtained by means of ultraviolet rays of a wavelength of between 200 and 400 nm, for a period of time sufficient to enable the cross-linking.

The present invention relates to a novel method of preparing films based on cross-linked poly(ethylene oxide), the films thus obtained, as well as their use in particular as biomaterials.

The invention can in particular be used in the fields of pharmacy, cosmetics, plastic surgery and the food industry.

It is known that hydrogels are three-dimensional macromolecular networks which retain significant amounts of aqueous liquids, and which, due their particular physico-chemical properties, have been put to numerous uses in fields as varied as the food industry, the pharmaceutical industry, or the cosmetic industry.

Amongst these hydrogels, those based on poly(ethylene oxide) have been the subject of important recent developments due in particular to their strong potential for pharmaceutical applications.

To this day, three main routes exist for preparing networks based on poly(ethylene oxide)
physical cross-linking, by formation of hydrogen bonds, hydrophobic interactions or ionic interactions;
chemical cross-linking, by adding multifunctional groups which can induce a three-dimensional network; and
cross-linking by provision of energy, notably by irradiation with gamma or ultraviolet rays, under conditions enabling the generation of free radicals which can form a three-dimensional network by rearrangement.

The cross-linking of poly(ethylene oxide) by gamma rays has been described in particular in U.S. Pat. Nos. 3,264,202 and 3,419,006 for pure poly(ethylene oxide), and in U.S. Pat. Nos. 3,898,143, 3,993,551, 3,993,552 and 3,993,553 for mixtures of poly(ethylene oxide) and a water-soluble polymer of natural or synthetic origin.

The cross-linking of dry films of poly(ethylene oxide) by ultraviolet rays has been recommended in the method described in the document US H 1666 for the preparation of salified complexes that can be used in: the field of high energy batteries.

More specifically, the method described in this prior art document comprises the steps consisting in
a) dissolving poly(ethylene oxide), alone or in a mixture, with poly(methylene oxide), in a polar organic solvent, in the presence of a photo-initiating agent;
b) drying the solution thus obtained at 60° C. at reduced pressure for 12 hours, in order to obtain a film having a thickness of less than 0.5 mm;
c) subjecting the dry film thus obtained to ultraviolet rays of a wavelength of between 190 nm and 350 nm, for a period of time sufficient to enable the cross-linking.

It has been observed that the method described in this prior art document leads to a relatively mediocre cross-linking quality, and this manifests itself by imperfect mechanical properties of the films thus obtained.

More specifically, since the cross-linking takes place preferentially in the amorphous domains of the sample, an inhomogeneous distribution of cross-linking is observed, which results notably from the highly crystalline character of the poly(ethylene oxide).

Thus, the method described in the document US H 1666 leads to a non-controlled and inhomogeneous cross-linking of the film based on poly(ethylene oxide), and, consequently, leads to physical properties, such as characteristics of mechanical strength or of elongation, which are insufficient and which limit the possible applications thereof, above all in fields which necessitate hydrogels which are homogeneously swollen in water, and not simply cross-linked resins.

Under these conditions, an aim of the present invention is to solve the technical problem consisting of providing a novel method of preparing films based on cross-linked poly(ethylene oxide) enabling a controlled and homogenous cross-linking, in thus leading to films having mechanical properties, and notably mechanical properties of strength, which are improved with respect to products obtained according to the teaching of the state of the art.

It has been discovered, and this constitutes the basis of the present invention, that it was possible to solve this technical problem in a manner which is particularly simple and efficient, and which can be used on an industrial scale, by subjecting the film, before irradiation, to a controlled absorption of water enabling the crystallinity of the poly(ethylene oxide) matrix to be lowered, or at least enabling the size of the crystallites to be reduced.

This method is applicable not only within the context of the preparation of poly(ethylene oxide) films, but also within the context of the preparation of films based on copolymers of ethylene oxide, notably on copolymers of ethylene oxide and propylene oxide (PO), or, even, on copolymers of ethylene oxide and butylene oxide (BuO).

Such copolymers can be block copolymers or random copolymers, or graft copolymers.

Furthermore, it was noted that the presence of an additional polymer, other than the poly(ethylene oxide), enables the range of properties of the hydrogels obtained to be enlarged considerably.

Thus, according to a first aspect, the present invention relates to a method of preparing films based on cross-linked poly(ethylene oxide), characterized in that it comprises the steps consisting in
a) dissolving said polymer or copolymer of ethylene oxide, alone or in a mixture, with a water-soluble polymer, in a solvent system made up of water, an organic solvent, or a mixture in any proportion of water and of organic solvent, in the. presence of an effective amount of a photo-initiating agent or of a cross-linking agent;
b1) either drying the solution thus obtained until the solvent system has evaporated, when this solvent system is made up exclusively of an organic solvent,. to thus obtain a dry film, and treating the film thus obtained under conditions enabling an amount of water to be absorbed of between 10 and 100% by weight with respect to the weight of the polymer;
b2) or drying the solution thus obtained until the solvent system has evaporated, when this solvent system is made up.of water or a water-organic solvent mixture, to thus obtain a film containing between 10 and 100% by weight of water with respect to the weight of the dry film; and
c) irradiating the film thus obtained by means of ultraviolet rays of a wavelength of between 200 and 400 nm, for a period of time: sufficient to enable the cross-linking.

The poly(ethylene oxide) used within the context of the invention is not limited to a particular type of poly(ethylene oxide). However, according to a preferred embodiment, it has a molecular weight of between 100,000 and 8,000,000.

Similarly, the method according to the invention can be carried out with a large variety of copolymers, in particular copolymers of ethylene oxide and propylene oxide (PO), or copolymers of ethylene oxide and butylene oxide (BuO).

Generally speaking, these copolymers will have molecular weights of between 100 000 and 4 000 000, preferably between 200 000 and 2 000 000. The proportion of ethylene oxide in the copolymer will advantageously be of the order of 90% by weight relative to the weight of the copolymer.

The water-soluble polymer which is optionally used with the poly(ethylene oxide) can be any water-soluble polymer which is classically known to the person skilled in the art. Preferably, said water-soluble polymer is a polysaccharide.

Examples of polysaccharides which are advantageously used include cellulose polymers, pectins, carrageenans, and alginates.

Examples of cellulose polymers include
cationic cellulose ethers, such as quaternised hydroxyethyl celluloses;
non-ionic cellulose ethers, such as hydroxypropyl methyl cellulose, methyl cellulose, ethyl cellulose, and hydroxyethyl cellulose; and
anionic cellulose ethers, such as carboxymethyl cellulose.

An example of an alginate is sodium alginate.

Aromatic ketones, such as benzophenone and derivatives of benzophenone, and quinones, such as camphorquinone, which are capable of extracting the hydrogen atom from hydrogen donor molecules, can be cited amongst the photo-initiating agents which can be used in step a).

Pentaerythritol triacrylate, pentaerythritol tetraacrylate, 2-ethyl-2-(hydroxymethyl)-1,3-propandiol trimethacrylate, monosaccharide diacrylates, ethylene glycol acrylates, and triacyl glycerols, can be cited amongst the cross-linking agents which can be used in step a).

According to an embodiment, when an organic solvent without water is used as solvent system, the treatment of the film enabling the absorption of water in step b1) is carried out by subjecting the dry film, which is obtained by drying said solvent, to water vapours, preferably in a closed chamber under a controlled atmosphere of water vapour.

Typically, the degree of crystallinity of the poly(ethylene oxide) of the dry film is of the order of 70% and decreases after absorption of water.

The drying steps mentioned above are generally carried out at room temperature, when the solvent system is made up of an organic solvent (step b1), and in an oven at reduced pressure at 35° C. for 4 hours, when the solvent system is made up of water or a water-organic solvent mixture (step b2).

The invention will now be better understood with. the aid of the Examples below which are in no way conceived to limit the scope thereof.

The properties of the films obtained in the following Examples were determined in the following manner:
Gel fraction (GF): the irradiated samples are weighed and are then placed for 24 hours in a Soxhlet so as to extract, with an appropriate solvent, the portion of polymer which is not cross-linked. The sample is then dried at reduced pressure so as to remove.the residual solvent, and is then dried. The gel fraction is then defined as the ratio of the weight of the sample having undergone an extraction to the initial weight of the sample.
Swelling at equilibrium (SE): At room temperature, the dry disks of cross-linked gels, the extractable portion of which has been taken out beforehand, are placed in a given solvent for 72 hours. The hydrogel disk is then taken out of the solvent, weighed, and then dried again at reduced pressure until a constant weight is attained, and, finally, weighed again. The ratio of these two weighings (mass of the solvated disk/mass of the dry disk) is the proportion of swelling at equilibrium.
DSC crystallinity (a DSC): The microscopic structure of the polymers in the solid state shows that these polymers are not in general entirely crystalline, but are in the form of a mixture of crystalline regions and amorphous regions. In order to characterise them better, the notion of crystallinity was defined as being the ratio of the enthalpy of fusion of the material to be analysed and the enthalpy of fusion of an entirely crystalline reference polymer (B. Wunderlich, Macromolecular physics, Vol. 3, Academic Press, New York, 1984).
Tensile strength (a): The force necessary for the rupture of the sample, measured according to the Standard EN ISO 527-1 (rate of deformation: 250 mm/min; dimensions of the samples: 30/6 mm; force applied: 40 N).
Elongation: Ratio of the maximum length of the sample before its rupture, to the initial length of the sample before elongation, measured according to the Standard EN ISO 527-1.
Water content: Ratio of the mass of water incorporated in the sample to the initial mass of the sample.
Enthalpy (ΔHₘ): Fusion energy of a polymer expressed in j/g, measured by differential scanning calorimetry.

### EXAMPLE 1

Preparation of Poly(ethylene oxide) (PEO) Films According to the Invention 3 g of poly(ethylene oxide), having a molecular weight of 1,000,000, are added to 150 ml of CH₂CI₂ containing 0.15 g of pentaerythritol triacrylate, while stirring vigorously. The homogeneous viscous solution was poured into a glass Petri dish until a maximum thickness of 220 μm was obtained, which solution was kept in the dark for a period of time sufficient to enable the solvent to evaporate off in free air.

The sample thus obtained was subjected to additional drying for 1 hour at reduced pressure at ambient temperature.

Samples were cut out in a rectangular shape, and they were fixed onto a polyester sheet-type support, they were weighed and were placed in a closed recipient (a dessicator) containing water in its lower part.

Each sample was kept in the dessicator at 30° C. for a set period of time so as to obtain the desired water content. The amount of water absorbed was determined by weighing.

The samples were irradiated at 25° C. for 30 minutes with the aid of a 150W mercury lamp which emits white light, 28% of the emitted energy of which is in the ultraviolet wavelength range.

A whole range of films, pre-hydrated before the cross-linking, was thus prepared.

The properties of swelling at equilibrium and the gel fraction properties of these films were measured and the results obtained are indicated in Table 1 below.

Furthermore, the thermal properties of these films were measured and the results obtained were indicated in Table 2, in which the evolution of the proportion of crystallinity, as a function of the initial water content of the sample, can also be seen.

TABLE 1
Characteristics of cross-linking of PEO films, cross-linked by UV,
as a function of the water absorbed before irradiation.

| | Water absorbed % | | | | | | | | | | |
|---|---|---|---|---|---|---|---|---|---|---|---|
| | 0 | 11 | 16 | 26 | 32 | 38 | 43 | 60 | 70 | 87 | 97 |
| GF % | 86.6 | 85.3 | 77.6 | 74.9 | 66.8 | 82.7 | 74.7 | 70.0 | 66.2 | 80.0 | 79.3 |
| SE % | 4.4 | 5.0 | 8.1 | 10.4 | 20.2 | 11.7 | 14.0 | 14.4 | 27.0 | 17.8 | 20.1 |

TABLE 2
Thermal properties and crystallinity of PEO films, cross-linked
by UV, as a function of the water absorbed before irradiation

| | Tₘ | | |
|---|---|---|---|
| | ° C. | | |
| Water | (Melting | ΔHₘ | Degree of |
| absorbed % | temperature) | J/g | crystallinity |
| 0 | 68.7 | 134.3 | 0.71 |
| 6 | 67.5 | 136.8 | 0.70 |
| 25 | 51.5 | 118.5 | 0.63 |
| 41 | 44.7 | 100.4 | 0.53 |
| 47 | 30.6 | 76.9 | 0.41 |

In order to demonstrate the originality of the invention, the properties of the films obtained according to the invention and having a water content of 27% before irradiation were compared with those of films of poly(ethylene oxide) without water which were not-irradiated or irradiated according to the state of the art.

The results thus obtained are indicated in Table 3 below.

TABLE 3
Properties of films of PEO which are non-irradiated, irradiated
according to the invention, and according to the state of the art.

| | GF, | | σ, | | Tm, | DSC |
|---|---|---|---|---|---|---|
| Composition | (%) | SE | kg/cm² | Elongation, % | (° C.) | (α) |
| PEO Non- | / | / | 182 | 833 | 68.6 | 0.76 |
| irradiated | | | | | | |
| Irradiated PEO | 74.2 | 4.2 | 291 | 608 | 67.3 | 0.67 |
| 0% H₂O | | | | | | |
| PEO + 25% H₂O | 70.3 | 11.3 | 213 | 600 | 67.7 | 0.70 |
| Irradiated | | | | | | |
| PEO + 60% H₂O | 60.1 | 20.7 | 269 | 519 | 45.1 | 0.52 |
| irradiated | | | | | | |

As Table 3 shows, if a comparison is made between a film of PEO, irradiated dry according to the state of the art (3^{rd} line of the Table) and the films irradiated in the presence of 25% and of 60% of water according to the invention (4^{th} and 5^{th} lines of the Table), it appears clearly that for a gel fraction which only decreases slightly, the proportions of swelling at equilibrium are clearly improved (20.7 instead of 4.2 going via 11.3), while the tensile strength and elongation remain of the same order of magnitude (around 250 for the resistance and 600 for the elongation).

Making the comparison this time with a PEO film which is dry but non-treated (2^{nd} line of the Table), it is clear that the films which are irradiated in the presence of water have a performance which is superior in terms of tensile strength, which manifests itself logically by a lower elongation. Furthermore, the PEO film which is non-treated, and thus non-cross-linked, can in no way be used in the presence of water.

Thus, the method of the invention leads to novel products which possess properties which are of considerable interest, such as a swelling proportion and/or a tensile strength, improved over products known up to now.

These results can be correlated with the fact that the presence of water enables the proportion of crystallinity of the PEO initially present to be lowered, as can be noted upon reading Table 2 above.

### EXAMPLE 2

Preparation of Poly(ethylene oxide) (PEO)/Dolysaccharide Films According to the Invention.

A mixture of poly(ethylene oxide), having a molecular weight of 1,000,000, and polysaccharide (total amount 3 g), is added to 150 ml of a solvent system, depending upon the nature of the. polysaccharide, such as, for example, a solvent based on CH₂CI₂/ethanol (1:1), when the polysaccharide is hydroxypropylmethylcellulose, and containing 0.15 g of pentaerythritol triacrylate while stirring vigorously.

The homogeneous viscous solution was poured into a glass Petri dish (thickness 220 μm) that was kept in the dark for a period of time sufficient to enable the solvent to evaporate off in free air.

Films were thus prepared from mixtures of mass ratios of 9:1, 7:3 and 5:5, having a thickness of 150 to 250 μm.

The sample was subjected to additional drying for 1 hour at reduced pressure at room temperature.

Samples were cut out in a rectangular shape, and they were fixed onto a polyester sheet-type support, they were weighed and were placed in a closed recipient (a dessicator) containing water in its lower part.

Each sample was kept in the dessicator at 30° C. for a set period of time so as to obtain the desired water content. The amount of water absorbed was determined by weighing.

The samples were irradiated at 25° C. for 30 minutes with the aid of a 150W mercury lamp situated at 1 cm from the samples and emitting the whole ultraviolet range.

As a comparison, films. based on poly(ethylene oxide) and polysaccharide were prepared by making use of the experimental protocol indicated above, with the exception of the step leading to the absorption of water.

The properties of the films thus prepared according to the invention, and of those prepared for comparison, were measured, and the results obtained are given
in Table 4A, for the films the polysaccharide of which is hydroxypropylmethylcellulose (HPMC);
in Table 4B, for the films the polysaccharide of which is sodium alginate (Alg)
in Table 4C, for the films the polysaccharide of which is chitosan
in Table 4D, for the films the polysaccharide of which is ethyl cellulose (EC);
in Table 4E, for the films the polysaccharide of which is carboxymethylcellulose (CMC); and
in Table 4F, for the films the polysaccharide of which is carrageenan.

These results show the superiority of the films obtained according to the invention, by comparison with the films obtained according to the method described in the state of the art. It is noted that these results are comparable, whatever the nature of the polysaccharide used.

TABLE 4A

| | | | | | | | |
|---|---|---|---|---|---|---|---|
| PEO | Water | | | | Elon- | | |
| components: | content, % | | | σ, | gation, | Tm, | α |
| HPMC | by weight | GF, % | SE | kg/cm² | % | ° C. | DSC |

a) dry films irradiated according to the state of the art

| | | | | | | | |
|---|---|---|---|---|---|---|---|
| 90:10 | 0 | 85.1 | 3.6 | 14.2 | 15.6 | 70.4 | 0.77 |
| 70:30 | 0 | 81.2 | 3.6 | 25.5 | 9.6 | 67.6 | 0.74 |
| 50:50 | 0 | 69.8 | 5.0 | 35.2 | 7.5 | 65.5 | 0.64 |

b) films irradiated with pre-absorbed H₂O
according to the invention

| | | | | | | | |
|---|---|---|---|---|---|---|---|
| 90:10 | 26 | 83.5 | 8.3 | 98.0 | 24.6 | 68.8 | 0.66 |
| 70:30 | 26 | 69.0 | 7.4 | 91.0 | 16.7 | 68.8 | 0.65 |
| 50:50 | 26 | 57.5 | 9.3 | 140.0 | 18.8 | 65.8 | 0.62 |

TABLE 4B

| | | | | | | | |
|---|---|---|---|---|---|---|---|
| PEO | Water | | | | Elon- | | |
| components: | content, % | GF, | | σ, | gation, | Tm, | α |
| Alg | by weight | % | SE | kg/cm² | % | ° C. | DSC |

a) irradiated dry films

| | | | | | | | |
|---|---|---|---|---|---|---|---|
| 90:10 | 0 | 83.0 | 4.3 | 26.5 | 155 | 66.9 | 0.71 |
| 70:30 | 0 | 73.2 | 9.4 | 29.0 | 8.6 | 66.5 | 0.73 |
| 50:50 | 0 | 45.0 | 14.2 | 23.2 | 6.0 | 67.1 | 0.79 |

b) films irradiated with pre-absorbed H₂O

| | | | | | | | |
|---|---|---|---|---|---|---|---|
| 90:10 | 26 | 55.5 | 29 | 105.0 | 11.2 | 67.6 | 0.63 |
| 70:30 | 26 | 48.0 | 118 | 79.0 | 7.9 | 68.4 | 0.70 |
| 50:50 | 26 | 42.6 | 169 | 58.0 | 10.0 | 66.0 | 0.70 |

TABLE 4C

| | | | | | | | |
|---|---|---|---|---|---|---|---|
| PEO | Water | | | | Elon- | | |
| components: | content, % | | | σ, | gation, | Tm, | α |
| chitosan | by weight | GF, % | SE | kg/cm² | % | ° C. | DSC |

a) irradiated dry films

| | | | | | | | |
|---|---|---|---|---|---|---|---|
| 90:10 | 0 | 77.4 | 2.9 | 316 | 402 | 65.5 | 0.56 |
| 70:30 | 0 | 78.1 | 2.6 | 494 | 76 | 62.4 | 0.49 |
| 50:50 | 0 | 76.4 | 2.1 | 592 | 62 | 61.10 | 0.48 |

b) films irradiated with pre-absorbed H₂O

| | | | | | | | |
|---|---|---|---|---|---|---|---|
| 90:10 | 25 | 71.8 | 5.1 | 253 | 546 | 62.0 | 0.39 |
| 70:30 | 25 | 79.8 | 3.2 | 422 | 58 | 60.5 | 0.33 |
| 50:50 | 25 | 70.7 | 3.2 | 429 | 11 | 60.1 | 0.26 |

TABLE 4D

| | | | | | | | |
|---|---|---|---|---|---|---|---|
| PEO | Water | | | σ, | | | |
| components: | content, % | GF, | | kg/ | Elongation, | Tm, | α |
| EC | by weight | % | SE | cm² | % | ° C. | DSC |

a) irradiated dry films

| | | | | | | | |
|---|---|---|---|---|---|---|---|
| 90:10 | 0 | 86.5 | 3.4 | 450 | 25.0 | 65.5 | 0.58 |
| 70:30 | 0 | 83.4 | 3.3 | 346 | 5.6 | 62.4 | 0.49 |
| 50:50 | 0 | 74.2 | 3.1 | 316 | / | | |

b) films irradiated with pre-absorbed H₂O

| | | | | | |
|---|---|---|---|---|---|
| 90:10 | 26 | 218 | 402 | 68.3 | 67.0 |
| 70:30 | 26 | 252 | 113 | 67.0 | 66.0 |
| 50:50 | 26 | 186 | 14.4 | 67.3 | 66.0 |

TABLE 4E

| | | | | | | | |
|---|---|---|---|---|---|---|---|
| PEO | Water | | | | Elon- | | |
| components: | content, % | GF, | | σ, | gation, | Tm, | α |
| CMC | by weight | % | SE | kg/cm² | % | ° C. | DSC |

a) irradiated dry films

| | | | | | | | |
|---|---|---|---|---|---|---|---|
| 90:10 | 0 | 79.0 | 5.0 | 188 | 22.0 | 66.6 | 0.65 |
| 70:30 | 0 | 74.0 | 5.1 | 176 | 15.0 | 67.6 | 0.63 |
| 50:50 | 0 | 53.0 | 6.6 | 158 | 3.0 | 66.1 | 0.59 |

b) films irradiated with pre-absorbed H₂O

| | | | | | | | |
|---|---|---|---|---|---|---|---|
| 90:10 | 26 | 58.2 | 15.4 | 200 | 31 | 66.3 | 0.71 |
| 70:30 | 26 | 55.2 | 24.5 | 216 | 43 | 65.4 | 0.72 |
| 50:50 | 26 | 41.2 | 25.8 | / | / | 65.4 | 0.69 |

TABLE 4F

| | | | | | | | |
|---|---|---|---|---|---|---|---|
| PEO | Water | | | | Elon- | | |
| components: | content, % | GF, | | σ, | gation, | Tm, | α |
| carrageenan | by weight | % | SE | kg/cm² | % | ° C. | DSC |

a) irradiated dry films s

| | | | | | | | |
|---|---|---|---|---|---|---|---|
| 90:10 | 0 | 86.9 | 4.1 | 321 | 50.0 | 68.8 | 0.6 |
| 70:30 | 0 | 82.9 | 4.3 | 390 | 11.0 | 62.2 | / |
| 50:50 | 0 | 85.8 | 3.7 | 261 | 30.0 | 65.2 | 0.75 |

b) films irradiated with pre-absorbed H₂O

| | | | | | | | |
|---|---|---|---|---|---|---|---|
| 90:10 | 26 | 61.3 | 24.4 | 256 | 341 | 67.2 | 0.67 |
| 70:30 | 26 | 56.4 | 34.9 | 248 | 26 | 65.8 | 0.57 |
| 50:50 | 26 | 46.0 | 70.1 | 348 | 56 | 60.0 | 0.39 |

### EXAMPLE 3

Characteristics of Cross-linking of PEO Films as a Function of the Cross-linking Agent, in the Presence of 25% Pre-absorbed Moisture.

TABLE 5

| cross- | | | | | | | |
|---|---|---|---|---|---|---|---|
| linking | | SE | SE | σ, | Elon- | Tm, | DSC |
| agent | GF, % | H₂O | CHCl₃ | kg/cm² | gation, % | ° C. | α |
| PEO non- | | | | 182 | >833 | 68.6 | 0.76 |
| irradiated | | | | | | | |
| PETA-1 | 78.1 | 5.9 | 8.6 | 201 | 120 | 68.3 | 0.63 |
| PETA-2 | 77.8 | 5.6 | 8.2 | 174 | 34 | 68.1 | 0.66 |
| TMPTM | 53.5 | 15.3 | 25.8 | 106 | >600 | 67.1 | 0.68 |
| TEGDM | 43.7 | 18.0 | 37.0 | 115 | 520 | 65.2 | 0.70 |

PETA-1: pentaerythritol triacrylate
PETA-2: pentaerythritol tetraacrylate
TMPTM: trimethylolpropane trimethacrylate
TEGDM: tetra(ethylene glycol) dimethacrylate

The results relating to the gel fraction demonstrate the fact that the methacrylates are less efficient than the acrylates in terms of photo-initiation and of cross-linking.

### EXAMPLE 4

Preparation of Films of Copolymers of Poly(ethylene oxide) According to the Invention

Random and block amphiphilic copolymers, of various poly(ethylene oxide)/poly(propylene oxide) ratios, were prepared according to a technique known in the literature.

After characterisation, these copolymers were used for the preparation of films which are cross-linked according to the invention. 3 g of poly(ethylene oxide) copolymer, having a defined composition, are added to 150 ml of CH₂CI₂ containing 0.15 g of pentaerythritol triacrylate while stirring vigorously. The homogeneous solution was poured into a glass Petri dish until a maximum thickness of 220 μm was obtained, which solution was kept in the dark for a period of time sufficient to enable the solvent to evaporate off in free air.

The sample thus obtained was subjected to additional drying for 1 hour at reduced pressure at room temperature.

Samples were cut out in a rectangular shape, and they were fixed onto a polyester sheet-type support, they were weighed and were placed in a closed recipient (a dessicator) containing water in its lower part.

Each sample was kept in the dessicator at 30° C. for a set period of time so as to obtain the desired water content. The amount of water absorbed was determined by weighing.

The samples were irradiated at 25° C. for 30 minutes with the aid of a 150W mercury lamp which emits white light, 28% of the emitted energy of which is in the ultraviolet wavelength range.

A range of films of varying poly(ethylene oxide) content was thus prepared.

The properties of swelling at equilibrium and the gel fraction properties of these films were measured and the results obtained are indicated in Tables 6 and 7 below, to which have been added the results of the mechanical and thermal studies.

TABLE 6

| | | | | | Elon- | | |
|---|---|---|---|---|---|---|---|
| Composition, | | SE | SE | σ | gation, | Tm | α |
| PO % by mass | GF % | H₂O | CHCl₃ | kg/cm² | % | ° C. | DSC |
| PEO | | | | 20.5 | 26.0 | 68.4 | 0.64 |
| P(EO-co-PO) | | | | | | | |
| 3.7 | 81.5 | 4.9 | 15.0 | 244 | 353 | 68.8 | 0.64 |
| 4.9 | 77.5 | 5.4 | 21.1 | 200 | 37 | 67.0 | 0.63 |
| 5.6 | 70.0 | 3.4 | 12.1 | 99 | 63 | 67.3 | 0.59 |
| 7.0 | 64.0 | 5.9 | 20 | 156 | 56 | 63.4 | 0.67 |
| 11.0 | 57.0 | 10 | 24.1 | 149 | 312 | 60.4 | 0.58 |
| P(EO-r-PO) | | | | | | | |
| 6.2 | 91.0 | 4.9 | 5.8 | 189.5 | 650 | 59.6 | 0.48 |
| 8.0 | 89.0 | 5.5 | 7.8 | 106.7 | 470 | 57.6 | 0.45 |
| 9.2 | 82.0 | 6.5 | 9.3 | 80.7 | 595 | 57.5 | 0.46 |

TABLE 7

| Composition | | | | | Elon- | | |
|---|---|---|---|---|---|---|---|
| of water, | | SE | SE | σ | gation, | Tm | α |
| % by mass | GF % | H₂O | CHCl₃ | kg/cm² | % | ° C. | DSC |
| PEO | | | | | | | |
| 0 | 74.2 | 4.2 | 7.0 | 291 | 608 | 67.3 | 0.67 |
| 26 | 70.3 | 11.3 | 20.0 | 213 | >600 | 67.7 | 0.70 |
| 39 | 67.8 | 13.3 | 23.8 | 194 | 81 | 68.2 | 0.76 |
| 55 | 60.1 | 20.7 | 38.3 | >269 | >519 | 68.5 | 0.74 |
| P(EO-b-PO), | | | | | | | |
| 1.5% PO | | | | | | | |
| 0 | 49.6 | 7.2 | 9.5 | 238 | 7.6 | 65.0 | 0.64 |
| 25 | 38.2 | 24.7 | 50.4 | 259 | 14.6 | 64.9 | 0.75 |
| 40 | 20.3 | 42.2 | 150 | 98 | 727 | 65.7 | 0.74 |
| 60 | 14.5 | 64.8 | 260 | >314 | >833 | 66.5 | 0.61 |
| P(EO-r-PO), | | | | | | | |
| 3.2% PO | | | | | | | |
| 0 | 41.3 | 14.0 | 17.1 | 189 | 650 | 59.5 | 0.57 |
| 25 | 21.4 | 20.0 | 34.5 | 110 | 480 | 59.1 | 0.54 |
| 40 | 17.9 | 51.2 | 61.1 | 51 | 9.3 | 59.8 | 0.59 |
| 60 | 13.8 | 27.8 | 120 | 71 | >833 | 61.8 | 0.67 |
| P(EO-r-BuO), | | | | | | | |
| 1.9 wt. % BuO | | | | | | | |
| 0 | 53.1 | 8.9 | 15.4 | 245 | 579 | 60.1 | 0.62 |
| 23 | 34.7 | 23.0 | 35.0 | >343 | >833 | 62.8 | 0.67 |
| 40 | 31.9 | 40.9 | 80.1 | >112 | >833 | 61.9 | 0.68 |
| 60 | 30.0 | 41.7 | 115.0 | >94 | >833 | 62.8 | 0.71 |
| P(EO-r-BuO), | | | | | | | |
| 3.3 wt. % BuO | | | | | | | |
| 0 | 61.7 | 5.2 | 7.2 | 331 | 684 | 57.0 | 0.53 |
| 25 | 52.2 | 31.6 | 78.1 | >111 | >833 | 59.8 | 0.53 |
| 40 | 42.2 | 35.1 | 102.0 | >121 | >833 | 58.5 | 0.59 |
| 60 | 40.2 | 43.0 | 126.0 | >83 | >833 | 58.7 | 0.58 |

1. A method of preparing films based on cross-linked poly(ethylene oxide), which comprises the steps consisting in:
a) dissolving a polymer or copolymer of ethylene oxide, alone or in a mixture with a water-soluble polymer, in a solvent system selected from the group consisting of water, an organic solvent, and a mixture in any proportion of water and of organic solvent, in the presence of an effective amount of a photo-initiating agent or of a cross-linking agent;
b1) either drying the solution thus obtained until the solvent system has evaporated, when this solvent system is made up exclusively of an organic solvent, to thus obtain a dry film, and treating the film thus obtained under conditions enabling an amount of water to be absorbed of between 10 and 100% by weight with respect to the weight of the polymer;
b2) or drying the solution thus obtained, when this solvent system is made up of water or a water-organic solvent mixture, under conditions enabling to obtain a film containing between 10 and 100% by weight of water with respect to the weight of the polymer; and
c) irradiating the film thus obtained by means of ultraviolet rays of a wavelength of between 200 and 400 nm, for a period of time sufficient to enable the cross-linking.

2. The method according to claim 1, wherein the water-soluble polymer is a polysaccharide.

3. The method according to claim 2, wherein the polysaccharide is selected from the group, consisting of cellulose polymers, pectins, carrageenans, and alginates.

4. The method according to claim 1, wherein the cellulose polymer mentioned above is a polymer selected from the group consisting of:
cationic cellulose ethers;
non-ionic cellulose ethers; and
anionic cellulose ethers.

5. The method according to claim 1, wherein the treatment of the film enabling the absorption of water in step b1) is carried out by subjecting the dry film obtained to water vapours.

6. The method according to claim 1, wherein the poly(ethylene oxide) has a molecular weight of between 100,000 and 8,000,000.

7. The method according to claim 1, wherein the photo-initiating agent is selected from the group consisting of aromatic ketones and quinones.

8. The method according to claim 1, wherein the cross-linking agent mentioned above is selected from the group consisting of pentaerythritol triacrylate, pentaerythritol tetraacrylate, 2-ethyl-2-(hydroxymethyl)-1,3-propandiol trimethacrylate, monosaccharide diacrylates, ethylene glycol acrylates, and triacyl glycerols.

9. The method according to claim 3, wherein the polysaccharide mentioned above is sodium alginate.

10. The method according to claim 4, wherein the polymer mentioned above is selected from the group consisting of quaternised hydroxyethylcellulose, hydroxypropylmethylcellulose, methylcellulose, ethylcellulose, hydroxyethylcellulose, and carboxymethylcellulose.

11. The method according to claim 5, wherein the treatment of the film enabling the absorption of water in step b1) is carried out by subjecting the dry film obtained to water vapours, in a closed chamber under a controlled atmosphere of water vapour.

12. The method according to claim 7, wherein the photo-initiating agent mentioned above is selected from the group consisting of benzophenone, derivatives of benzophenone, and camphorquinone.
